(19) United States
(12) Patent Application Publication
(10) Pub. No.: US 2023/0158661 A1
(43) Pub. Date: May 25, 2023

(54) Marked Lumber

(71) Applicant: Frank Hutchinson, Vanderhoof (CA)

(72) Inventor: Frank Hutchinson, Vanderhoof (CA)

(21) Appl. No.: 17/535,640

(22) Filed: Nov. 25, 2021

(51) Int. Cl. B25H 7/00; B41M 1/38; B27M 1/06

(52) U.S. Cl. CPC B25H 7/00; B27M 1/06; B41M 1/38; B23K 26/359

(57) ABSTRACT

A dimensional lumber product and method for marking them. The lumber is marked on a side at regular intervals. The marks may be made with laser, paint, or mechanical force. The marks enable a builder to make accurate cuts using the existing marks, without needing to measure and manually mark the lumber.

### FIELD OF THE INVENTION

The invention relates generally to lumber, in particular processing dimensional lumber for building.

### BACKGROUND OF THE INVENTION

Lumber products used in building are commonly available in standard sizes, called “dimensional lumber.” Typically two of the dimensions are standardized and the third varies, in standard increments. For example, stud lumber called “2×4s” or “2×6s” define the width and depth in inches, while the length varies from 6 to 20 feet. Similarly sheets may be provided as 4′×8′, describing the width and length in feet, while the thickness is available in standard fractions of inches. Metric dimensional lumber is similarly available in certain markets.

Builders buy dimensional lumber depending on the building codes and because they can rely on the simplicity of standard measures. The builders then cut the lumber along one of the dimensions to fit the project, such as frame, roof, or stud wall. For example the building code may call for a 2×6 joist, whereby the length is cut to the relevant span.

Cutting the lumber, while not arduous, requires measuring the required distance from one with a tape measure, marking a line across the lumber and making the cut. The present invention provides lumber and method for simplifying these steps.

### SUMMARY OF THE INVENTION

To address the shortcomings of the current devices, a new form of lumber marking and methods of making markings is provided that has these advantages and solves certain problems mentioned above. Value added addition to existing lumber products.

In accordance with a first aspect of the invention there is provided a method dimensional lumber product comprising measurement markings at regular intervals along a side or face of the dimensional lumber product.

The markings may comprise numbers or a system of hash marks.

The markings may indicate a distance from a datum of the lumber

The markings may indicate a distance from a first end of the lumber along the side.

The lumber may further comprise second markings at regular intervals along a second side or face of the lumber product. The second markings may indicate a distance from a second end, opposite the first end.

The markings may represent metric or imperial measurements.

The markings may be one of laser etched, printed, painted, burned, or pressed.

In accordance with a second aspect of the invention there is provided a method of processing dimensional lumber comprising: moving the dimensional lumber relative to a marking device; making measurement markings at regular intervals along a side or face of the lumber product.

The markings may be printed or painted on to the side.

The marking device may comprise raised metal profiles that mark the lumber by burning or pressing under pressure and/or heat.

Further aspects of the invention are set out below and in the appended claims. Thus preferred embodiments of the invention enable builders to efficiently and accurately mark dimensional lumber before cutting.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1 is an isometric view of marked stud lumber.

FIG. 2 is an isometric view of marked sheet lumber.

FIG. 3 is a side view of angular marked lumber.

FIG. 4 is a detailed view of a marking system.

FIG. 5 is a side view of a carriage for marking lumber with a laser.

FIG. 6 is a top view of lumber and rotating marking device.

### DETAILED DESCRIPTION OF THE INVENTION

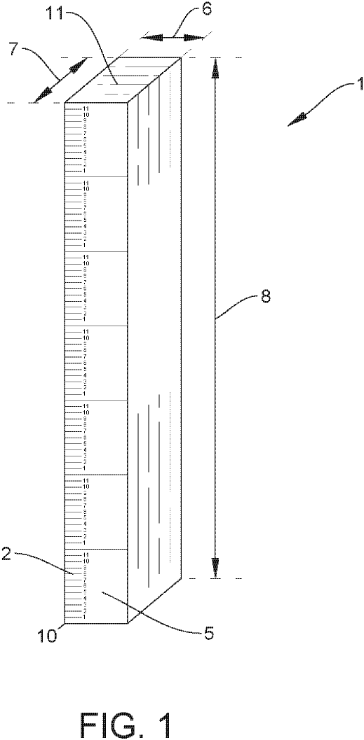

With reference to the accompanying figures, a lumber product and methods of making same are disclosed for simplifying cutting of lumber, particularly useful in building projects. As shown in FIG. 1, lumber product 1 is provided with markings 2 along one side 5. The lumber is one of the many dimensional lumber standards, having depth 6, width 7, and length 8 (from smallest to largest dimension). The markings indicate a measurement from a datum 10. The datum may be either or both such as one of the ends 11.

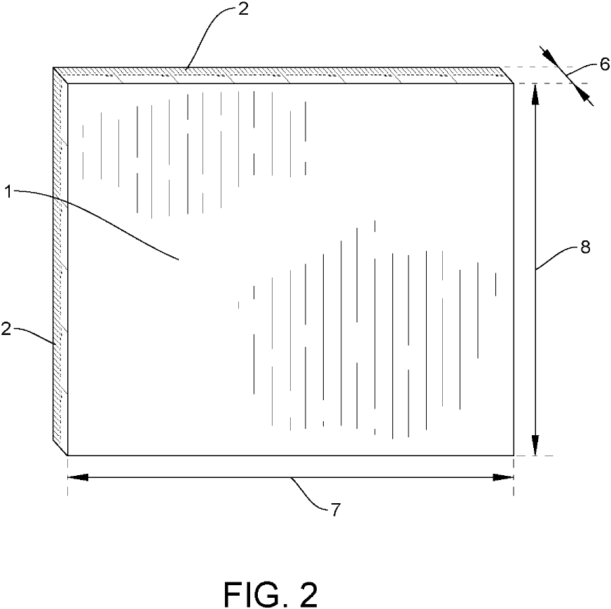

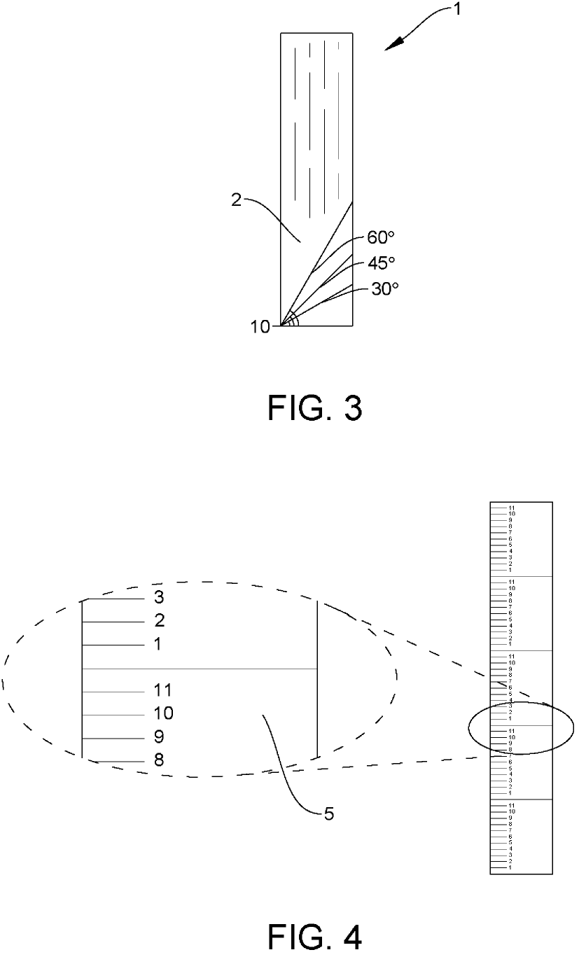

FIG. 2 shows similar markings for the case of sheets. FIG. 3 shows a marking system for angles from a corner to mark off common angle cuts. This may be useful in certain projects, such as roof trusses, where 30 °, 45 ° and 60 ° are common.

The builder simply identifies the marking for the measurement needed and cuts at and along that marking to get a piece of lumber of the desired size or angle. The cut is preferably made to the length in the case of stud lumber or length or width for sheets, but not to the smallest dimension of depth.

Sides and/or faces of lumber are marked at regular intervals to indicate measurements from a first end. Plural markings set may be provided on different sides of a single piece of lumber to indicate distance from different ends. This allows the builder to make two reliable cuts of a single piece of lumber because each of the ends is a datum (i.e fixed starting point). Alternatively the builder has the choice of cutting along the length or width in the case of sheet lumber. For clarity as used in industry and used herein, the largest surface is termed a ‘face’, the second largest 5 is termed a ‘side’ and the smallest surface 11 is termed an ‘end.’

The measurement can be imperial, metric, angles or another measure used in certain trades. The markings may be numbers and / or hash marks, preferably in regular intervals that indicate common measurements. The markings may comprise minor and major measures. In imperial systems, the markings may be inches and feet. In metric systems, the markings may be centimeters and meters. Hash marks are lines drawn across the side of the lumber, as shown in the detail of FIG. 4.

For certain projects, the marking system may include major marks for at additional distances that correspond to building codes, such as 16″ stud separation. Differences in fonts may be used to differentiate major and minor measures. In an exemplary marking system, the height of marks is between 0.2″ and 0.4″, the depth of the markings into the lumber is 0.01″ with minor intervals of 1″ and major intervals of 12″ and 16″.

The lumber may be studs, stud boards or sheets, including 2×4s, particle boards, plywood, Oriented Strand Boards. This lumber may be called unfinished lumber, being a wood product that is not finished or painted.

The markings are provided by a marking device in an industrial process, preferably at a sawmill before shipment to distribution. As described in more detail below, markings can be laser etched, burned, printed, painted, scribed, or pressed. Markings could be permanent or temporary by varying the paint composition or depth of impression. Thus in some cases the builder may remove the markings after cutting by sanding or washing to make the final product look clean. Alternatively permanent markings provide a simple identification of the lengths used in a project to future users, such as building inspectors or renovators.

In a preferred embodiment, the markings are laser etched or engraved. Advantageously, laser markings do not smudge or run. The lumber linearly moves relative to an industrial laser that burns the markings into the side. The laser may be a 2016 HSE 150 w laser by Kern Electronics. When used at 60% power, markings of sufficient depth are realized. Other lasers suitable for industrial settings may also be used.

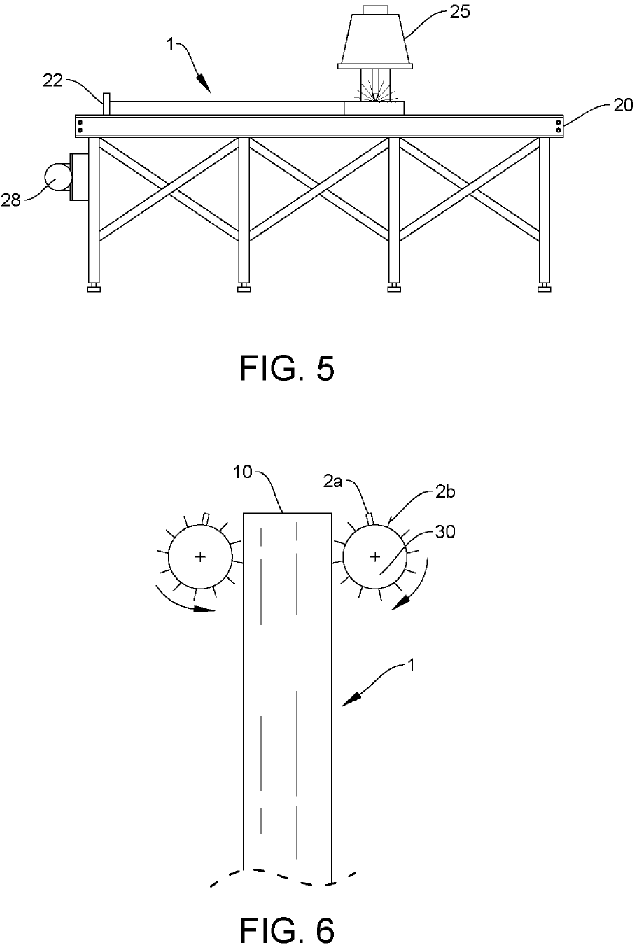

As shown in FIG. 5, lumber 1, moves precisely along a carriage 20 having an industrial laser 25. Servo motor 28 may drive a backstop 22 to precisely drive lumber 1. An encoder or scanner on the carriage may be used to determine the speed and position of the lumber as it moves, to control the timing of the laser. Alternatively the Laser may move over the lumber on a track that is controlled by computer giving speed and accuracy to the etching process.

The denser the wood, the higher temperature need to ignite and burn the marks. Soft wood such as pine, spruce ignite at 300° C., while denser wood such as fir or poplar can take a higher degree temp before burning. Preferably the marking system has controls to vary the temperature and time of marking in order to begin localized burning but not igniting the lumber.

In another embodiment, paint or ink is applied to the lumber. Advantageously paint an dink can be applied easily and removed with paint thinner or sanding to hide marks once installed. The ink used in most sawmills is oil based, such as SO11 Black Ink or LHDB-4245WR-Black from Samuel Packaging Group

In another embodiment, markings are made by pressing the lumber. A metal plate with raised profiles corresponding to the markings. The plate is then pressed into the side of the lumber and held under pressure depending on how deep the mark should be.

Alternatively the metal plate is heated by a resistive heating element to burn markings into the wood for several seconds, again depending on how deep the mark should be.

Pressing and/or burning may also be accomplished by a roller having the raised profile. The roller is pressed into engagement with the lumber at one end and rotates as the lumber moves passed it, as shown in FIG. 6. The profiles major 2a and minor 2b edges repeat along the side for the whole length of the lumber. This embodiment links the lumber’s linear movement with making the marking for perfect alignment from the datum 10.

1. A dimensional lumber product comprising measurement markings at regular intervals along a side or face of the dimensional lumber product.

2. The lumber of claim 1, wherein the markings comprise numbers.

3. The lumber of claim 1, wherein the markings comprise a system of hash marks.

4. The lumber of claim 1, wherein the markings indicate a distance from a datum of the lumber.

5. The lumber of claim 1, wherein the markings indicate a distance from a first end of the lumber along the side.

6. The lumber of claim 5, further comprising second markings at regular intervals along a second side or face of the lumber product.

7. The lumber of claim 6, wherein the second markings indicate a distance from a second end, opposite the first end.

8. The lumber of claim 1, wherein the markings represent metric or imperial measurements.

9. The lumber of claim 1, wherein the markings are one of laser etched, printed, painted, burned, or pressed.

10. A method of processing dimensional lumber comprising:
moving the dimensional lumber relative to a marking device; and
making measurement markings at regular intervals along a side or face of the lumber product.

11. The method of claim 10, wherein the markings comprise numbers.

12. The method of claim 10, wherein the markings comprise a system of hash marks.

13. The method of claim 10, wherein the markings are made from a datum of the lumber.

14. The method of claim 10, wherein the markings indicate a distance from a first end of the lumber along the side.

15. The method of claim 10, further comprising making second markings at regular intervals along a second side or face of the lumber product.

16. The method of claim 15, wherein the second markings indicate a distance from a second end, opposite the first end.

17. The method of claim 10, wherein the markings represent metric or imperial measurements.

18. The method of claim 10, wherein the markings are laser etched by the marking device.

19. The method of claim 10, wherein the markings are printed or painted on to the side.

20. The method of claim 10, wherein the marking device comprises raised metal profiles that mark the lumber by burning or pressing under pressure and/or heat.
